(19) United States
(12) Patent Application Publication
(10) Pub. No.: US 2025/0292950 A1
(43) Pub. Date: Sep. 18, 2025

(54) COIL COMPONENT

(71) Applicant: TDK Corporation, Tokyo (JP)

(72) Inventors: Yusuke NAGAI, Tokyo (JP); Hidenobu UMEDA, Tokyo (JP); Kouichi KAKUDA, Tokyo (JP); Shinichi SATO, Tokyo (JP); Kosuke ITO, Tokyo (JP); Youhei IIDA, Tokyo (JP); Mitsuharu KOIKE, Tokyo (JP); Keito YASUDA, Tokyo (JP); Takuya MIYASHITA, Tokyo (JP)

(73) Assignee: TDK Corporation, Tokyo (JP)

(21) Appl. No.: 19/064,966

(22) Filed: Feb. 27, 2025

(30) Foreign Application Priority Data
Mar. 14, 2024 (JP) 2024-039852

(51) Int. Cl. H01F 27/29

(52) U.S. Cl. CPC H01F 27/292

(57) ABSTRACT

A coil component includes: an element body including soft magnetic metal particles; a coil disposed inside the element body; and a first external electrode embedded in the element body to be exposed only from a mounting surface of the element body and connected to the coil. The first external electrode includes a first electrode portion having an exposed surface exposed from the mounting surface, and a second electrode portion projecting into the element body from the first electrode portion and spaced apart from the coil. An entirety of the second electrode portion is provided inside the element body.

### TECHNICAL FIELD

The present disclosure relates to a coil component. The present application claims priority to Japanese Patent Application No. 2024-039852 filed on Mar. 14, 2024, the content of which is incorporated herein by reference in its entirety.

### BACKGROUND

A coil component including an element body, a coil disposed inside the element body, and an external electrode provided only on a mounting surface of the element body is known (see, for example, WO 2011/135936 A1).

### SUMMARY

In the coil component above, the external electrode is provided only on the mounting surface of the element body, so that the external electrode is less likely to detach from the element body compared to a configuration in which the external electrode is provided across a plurality of surfaces of the element body.

It is an object of the present disclosure to provide a coil component that is capable of suppressing detachment of an external electrode.

(1) A coil component according to an embodiment of the present disclosure includes: an element body including soft magnetic metal particles; a coil disposed inside the element body; and a first external electrode embedded in the element body to be exposed only from a mounting surface of the element body and connected to the coil, wherein the first external electrode includes a first electrode portion having an exposed surface exposed from the mounting surface, and a second electrode portion projecting into the element body from the first electrode portion and spaced apart from the coil, and wherein an entirety of the second electrode portion is provided inside the element body.

In the coil component above, the first external electrode includes the second electrode portion projecting into the element body from the first electrode portion, with the entirety of the second electrode portion being provided inside the element body. Thus, a contact area between the first external electrode and the element body is increased compared to a configuration in which the first external electrode does not have the second electrode portion. This suppresses the detachment of the first external electrode from the element body.

(2) The coil component of (1) above may further include a second external electrode embedded in the element body to be exposed only from the mounting surface of the element body and connected to the coil, the first external electrode and the second external electrode may be spaced apart from each other, the first electrode portion may have an edge portion closer to the second external electrode, and the second electrode portion may project toward the second external electrode from the edge portion when viewed in a first direction perpendicular to the mounting surface. In this case, the second electrode portion can suppress the extension of cracks originating from a portion between the edge portion of the first electrode portion and the element body due to bending stress when the coil component is solder mounted on a circuit board.

(3) In the coil component of (2) above, an angle between the second electrode portion and the mounting surface may be greater than 0 degrees and less than 90 degrees. In this case, the second electrode portion can effectively suppress the extension of the cracks.

(4) In the coil component according to any one of (1) to (3) above, the element body may include an element body portion including a part of the mounting surface and covering the second electrode portion, and the element body portion may include a glass component. In this case, plating elongation can be suppressed.

(5) In the coil component of (4) above, the element body portion may further include the soft magnetic metal particles. In this case, the properties of the coil can be improved.

(6) In the coil component of any one of (1) to (5) above, the second electrode portion may include a protrusion penetrating between the soft magnetic metal particles. In this case, the detachment of the external electrode is further suppressed.

### BRIEF DESCRIPTION OF THE DRAWINGS

FIG. 1 is a perspective view of a coil component according to an embodiment.

FIG. 2 is a transparent perspective view of the coil component illustrated in FIG. 1.

FIG. 3 is the coil component illustrated in FIG. 1 viewed from a mounting surface side.

FIG. 4 is a cross-sectional view of the coil component illustrated in FIG. 1.

FIG. 5 is a cross-sectional view describing bending stress and cracks of the coil component illustrated in FIG. 1.

### DETAILED DESCRIPTION

Embodiments of the present disclosure will be described in detail below with reference to the accompanying drawings. Same reference signs are given to the same or corresponding elements in the description of the drawings, and redundant description will be omitted.

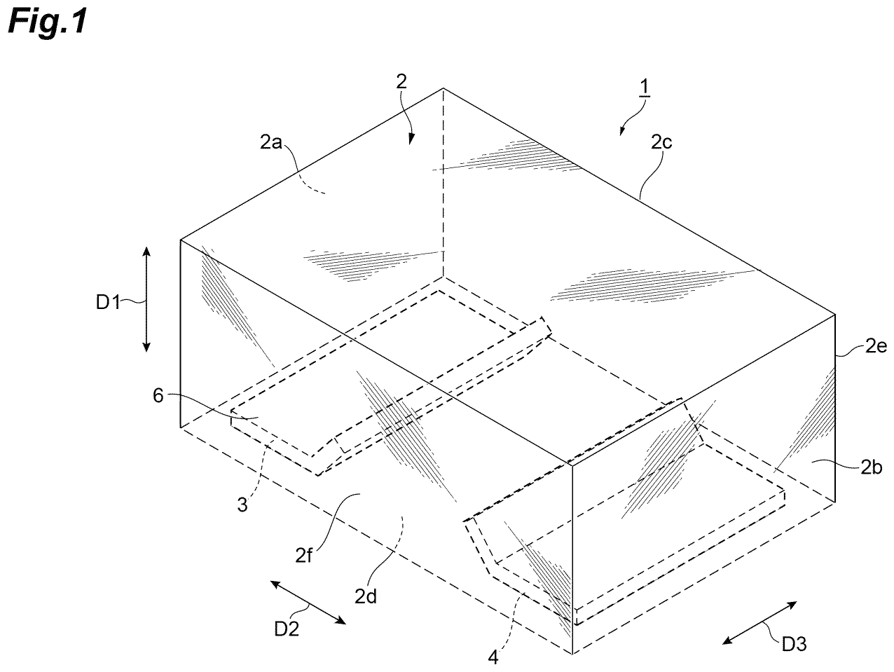

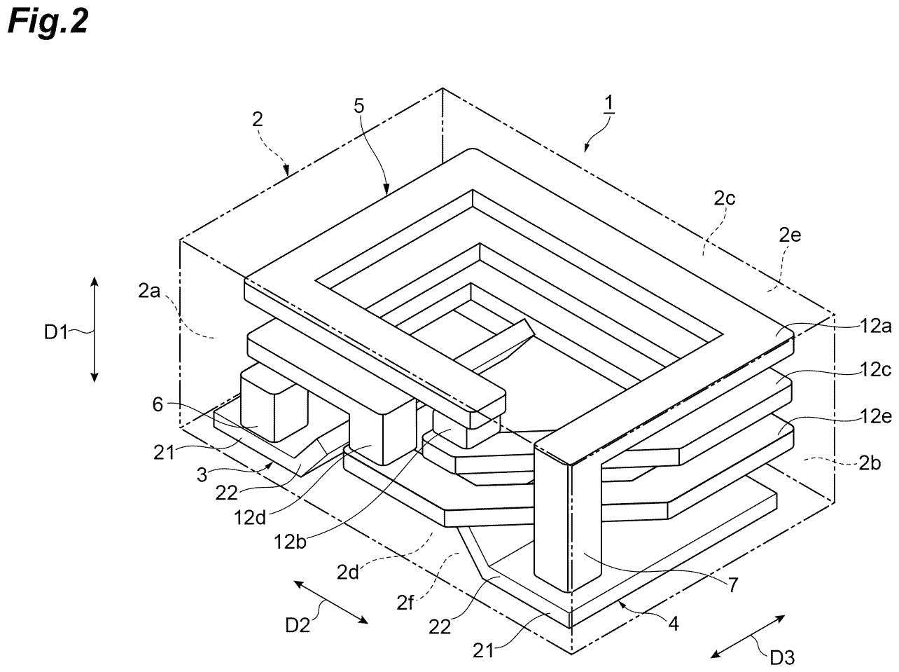

A coil component 1 according to an embodiment will be described with reference to FIGS. 1 to 4. As illustrated in FIGS. 1 to 4, the coil component 1 includes an element body 2, an external electrode 3, an external electrode 4, a coil 5, a first connecting conductor 6, and a second connecting conductor 7. The coil component 1 is a laminated coil component. In FIG. 2, the element body 2 is shown in broken lines for ease of explanation.

The element body 2 has a rectangular parallelepiped shape. The rectangular parallelepiped shape includes a rectangular parallelepiped shape in which the corners and edges are chamfered, and a rectangular parallelepiped shape in which the corners and edges are rounded. An outer surface 2s of the element body 2 has a pair of end surfaces 2a, 2b, a pair of main surfaces 2c, 2d, and a pair of side surfaces 2e, 2f. The end surfaces 2a, 2b face each other. The main surfaces 2c, 2d face each other. The side surfaces 2e, 2f face each other. In this embodiment, a facing direction of the main surfaces 2c, 2d is a first direction D1, a facing direction of the end surfaces 2a, 2b is a second direction D2, and a facing direction of the side surfaces 2e, 2f is a third direction D3. The first direction D1, the second direction D2, and the third direction D3 are substantially perpendicular to each other.

The end surfaces 2a, 2b extend in the first direction D1 so as to connect the main surfaces 2c, 2d. The end surfaces 2a, 2b also extend in the third direction D3 so as to connect the side surfaces 2e, 2f. The main surfaces 2c, 2d extend in the second direction D2 so as to connect the end surfaces 2a, 2b. The main surfaces 2c, 2d also extend in the third direction D3 so as to connect the side surfaces 2e, 2f. The side surfaces 2e, 2f extend in the first direction D1 so as to connect the main surfaces 2c, 2d. The side surfaces 2e, 2f also extend in the second direction D2 so as to connect the end surfaces 2a, 2b.

The main surface 2d is a mounting surface, and for example, when the coil component 1 is mounted on another electronic device not shown (e.g., a circuit board), it is the surface that faces the other electronic device. The end surfaces 2a, 2b are surfaces continuing from the mounting surface (i.e., the main surface 2d). The end surfaces 2a, 2b are also surfaces adjoining the mounting surface.

The element body 2 has a length in the second direction D2 that is greater than a length of the element body 2 in the first direction D1 and a length of the element body 2 in the third direction D3. The second direction D2 is a longitudinal direction of the element body 2. The element body 2 has a length in the third direction D3 that is greater than the length of the element body 2 in the first direction D1. That is, in this embodiment, the end surfaces 2a, 2b, the main surfaces 2c, 2d, and the side surfaces 2e, 2f have rectangular shapes. The length of the element body 2 in the first direction D1 may be equal to or greater than the length of the element body 2 in the third direction D3.

In the description of this embodiment, the term “equal” means the same, and may also refer to values including minute differences or manufacturing errors within a preset range, and the like. For example, if a plurality of values are within a ±5% range of the average of the plurality of values, it is defined that the plurality of values are equal.

The element body 2 is formed of a plurality of element body layers (magnetic layers) being laminated in the first direction D1. That is, a lamination direction of the element body 2 is the first direction D1. In the actual element body 2, the plurality of element body layers are integrated such that the boundaries between the layers cannot be visually recognized.

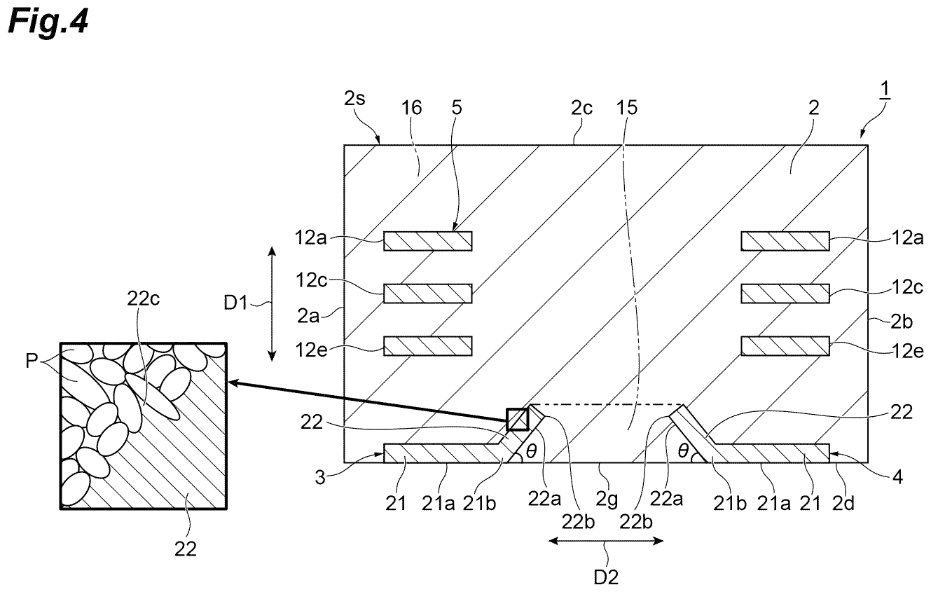

The element body 2 includes a plurality of soft magnetic metal particles P (see FIG. 4). The soft magnetic metal particles P are formed of a soft magnetic alloy (soft magnetic material). The soft magnetic alloy is, for example, an Fe—Si alloy. In the case in which the soft magnetic alloy is an Fe—Si alloy, the soft magnetic alloy may include P. The soft magnetic alloy may be, for example, an Fe—Ni—Si-M alloy. “M” includes one or more elements selected from the group consisting of Co, Cr, Mn, P, Ti, Zr, Hf, Nb, Ta, Mo, Mg, Ca, Sr, Ba, Zn, B, Al, and rare earth elements.

In the element body 2, the soft magnetic metal particles P, P are bonded. The bonding of the soft magnetic metal particles P, P is achieved, for example, by the bonding of oxide films (not shown) formed on the surfaces of the soft magnetic metal particles P. The oxide film has a thickness, for example, of 5 nm or more and 60 nm or less. The oxide film may be formed of one or a plurality of layers. A resin is present in at least a part of the gaps between the soft magnetic metal particles P, P. The resin has electrical insulation properties, and for example, may be a silicone resin, a phenol resin, an acrylic resin, or an epoxy resin.

As illustrated in FIG. 4, the element body 2 has a first element body portion 15 and a second element body portion 16. The first element body portion 15 is disposed between the external electrodes 3, 4 in the second direction D2. The first element body portion 15 includes a part of the mounting surface (main surface 2d). The first element body portion 15 is provided in contact with the external electrodes 3, 4 and to connect the external electrodes 3, 4. The second element body portion 16 is the part of the element body 2 other than the first element body portion 15.

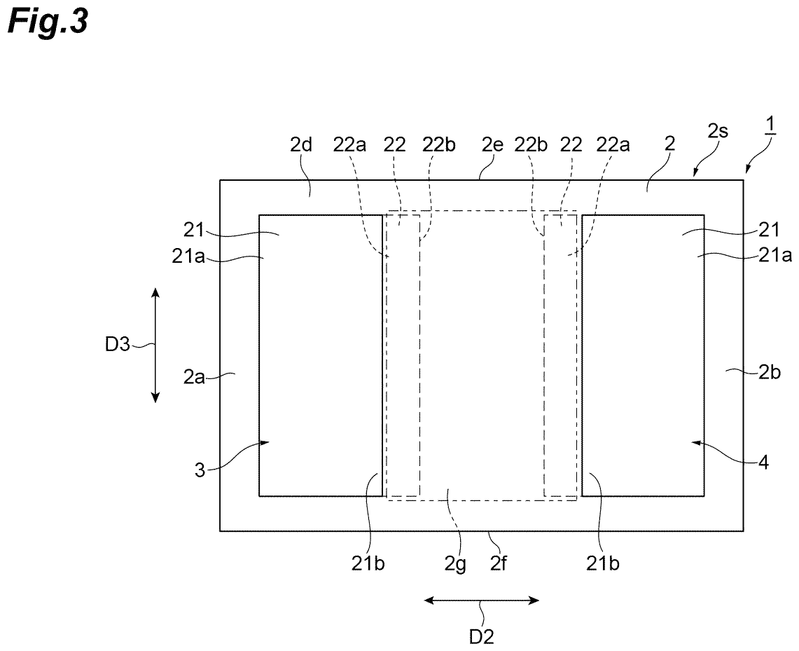

As illustrated in FIG. 3, the mounting surface (main surface 2d) has a center region 2g disposed between the external electrode 3 and the external electrode 4. The center region 2g has a rectangular shape with the second direction D2 being a short side direction, and the third direction D3 being a long side direction. The center region 2g extends in the second direction D2 and connects exposed surfaces 21a of the external electrodes 3, 4. Although in FIG. 3, the center region 2g and the exposed surfaces 21a of the external electrodes 3, 4 are spaced apart in the second direction D2 for the purpose of illustration, they are actually in contact with each other. Although in FIG. 3, a length of the center region 2g in the third direction D3 is greater than a length of the exposed surfaces 21a of the external electrodes 3, 4 in the third direction D3 for the purpose of illustration, they are actually the same.

The first element body portion 15 includes the center region 2g as a part of the mounting surface. The first element body portion 15 includes the entire center region 2g. The first element body portion 15 and the center region 2g overlap completely when viewed in the first direction D1. A length of the first element body portion 15 in the third direction D3 may be greater than the length of the center region 2g in the third direction D3.

In this embodiment, the first element body portion 15 includes a glass component. The second element body portion 16 does not include a glass component. It can thus be said that the content of the glass component in the first element body portion 15 is greater than the content of the glass component in the second element body portion 16. The first element body portion 15 further includes the soft magnetic metal particles P (see FIG. 4). The second element body portion 16 may include a glass component, but in this case, the content of the glass component in the first element body portion 15 is also greater than the content of the glass component in the second element body portion 16. The first element body portion 15 may, for example, be formed only of a glass component and need not contain the soft magnetic metal particles P. The first element body portion 15 may, for example, be formed only of the soft magnetic metal particles P and need not contain a glass component.

The external electrode 3 and the external electrode 4 are connected to the coil 5. The external electrode 3 and the external electrode 4 are embedded in the element body 2 so as to be exposed only from the mounting surface (main surface 2d). The external electrode 3 and the external electrode 4 are so-called bottom electrodes. The external electrode 3 and the external electrode 4 have the same shape. The external electrode 3 and the external electrode 4 are spaced apart from each other in the second direction D2. Specifically, the external electrode 3 is disposed closer to the end surface 2a of the element body 2, and the external electrode 4 is disposed closer to the end surface 2b of the element body 2. The external electrodes 3, 4 are formed of a conductive material such as Ag, Cu, Ni, Sn, or Au.

The coil 5 is disposed inside the element body 2. The coil 5 is formed of a plurality of coil conductor layers 12a to 12e. The plurality of coil conductor layers 12a to 12e are electrically connected to each other, and form the coil 5 inside the element body 2. A coil axis of the coil 5 is provided along the first direction D1. The coil conductor layers 12a to 12e are disposed so that at least portions thereof overlap each other when viewed in the first direction D1. The plurality of coil conductor layers 12a to 12e are formed of a conductive material (e.g., Ag or Pd). In this embodiment, the plurality of coil conductor layers 12a, 12c, 12e are plated conductors. The coil conductor layers 12a to 12e are disposed spaced apart from the end surfaces 2a, 2b, the main surfaces 2c, 2d, and the side surfaces 2e, 2f.

The first connecting conductor 6 is disposed inside the element body 2. The first connecting conductor 6 connects the external electrode 3 and the coil 5. The first connecting conductor 6 is a through hole conductor. The first connecting conductor 6 extends in the first direction D1, and is connected to the external electrode 3 and one end of the coil 5. The first connecting conductor 6 is formed of a plurality of first connecting conductor layers not shown. In this embodiment, a cross-section of the first connecting conductor 6 perpendicular to a direction of extension (first direction D1) (cross-section along the second direction D2 and the third direction D3) has a rectangular shape. That is, the first connecting conductor 6 has a rectangular prism shape.

The second connecting conductor 7 is disposed inside the element body 2. The second connecting conductor 7 connects the external electrode 4 and the coil 5. The second connecting conductor 7 is a through hole conductor. The second connecting conductor 7 extends in the first direction D1, and is connected to the external electrode 4 and the other end of the coil 5. The second connecting conductor 7 is formed of a plurality of second connecting conductor layers not shown. In this embodiment, a cross-section of the second connecting conductor 7 perpendicular to a direction of extension (first direction D1) (cross-section along the second direction D2 and the third direction D3) has a rectangular shape. That is, the second connecting conductor 7 has a rectangular prism shape.

The external electrode 3 and the external electrode 4 will next be described in detail. The external electrode 3 and the external electrode 4 have a rectangular shape with the second direction D2 being the short side direction, and the third direction D3 being the long side direction when viewed in the first direction D1. The external electrode 3 and the external electrode 4 are disposed spaced apart from outer edges of the main surface 2d.

Each of the external electrodes 3, 4 includes a first electrode portion 21 and a second electrode portion 22. The first electrode portion 21 is embedded in the element body 2. The first electrode portion 21 has the exposed surface 21a exposed from the mounting surface (main surface 2d). The exposed surface 21a forms the same plane as the main surface 2d. The first electrode portion 21 of the external electrode 3 is connected to one end of the coil 5 by the first connecting conductor 6. The first electrode portion 21 of the external electrode 4 is connected to the other end of the coil 5 by the second connecting conductor 7. In this embodiment, each of the external electrodes 3, 4 has a bent shape in which the second electrode portion 22 is bent toward the inside of the element body 2.

The first electrode portion 21 has an edge portion 21b closer to the center in the second direction D2 of the element body 2. The external electrodes 3, 4 are disposed so that the edge portions 21b of the first electrode portions 21 face each other in the second direction D2. It can be said that the first electrode portion 21 of the external electrode 3 has the edge portion 21b closer to the external electrode 4. It can also be said that the first electrode portion 21 of the external electrode 4 has the edge portion 21b closer to the external electrode 3.

The second electrode portion 22 projects into the element body 2 from the edge portion 21b of the first electrode portion 21. The second electrode portion 22 is spaced apart from the coil 5 and is not directly connected to the coil 5. The entire second electrode portion 22 is provided inside the element body 2. The second electrode portion 22 is not exposed from the element body 2. The second electrode portion 22 projects toward the center of the element body 2 in the second direction D2 when viewed in the first direction D1. That is, the second electrode portion 22 of the external electrode 3 projects toward the external electrode 4 in the second direction D2 when viewed in the first direction D1. Additionally, the second electrode portion 22 of the external electrode 4 projects toward the external electrode 3 in the second direction D2 when viewed in the first direction D1.

The second electrode portion 22 projects so as to overlap the center region 2g when viewed in the first direction D1. A tip end 22b of the second electrode portion 22 is disposed closer to the center of the element body 2 in the second direction D2 than the edge portion 21b of the first electrode portion 21 when viewed in the first direction D1.

An angle θ between the second electrode portion 22 and the mounting surface (main surface 2d) is, for example, greater than 0 degrees and less than 90 degrees (0<θ<90). The second electrode portion 22 has a side surface 22a that is covered by the first element body portion 15. The side surface 22a is a surface adjoining the exposed surface 21a. The side surface 22a is also a surface adjacent the center region 2g. Specifically, the angle θ is the angle between the side surface 22a of the second electrode portion 22 and the center region 2g. An angle between the exposed surface 21a and the side surface 22a (180-θ) is, for example, greater than 90 degrees and less than 180 degrees (90<180-θ<180).

The second electrode portion 22 has a protrusion 22c that penetrates between the soft magnetic metal particles P. The protrusion 22c is formed, for example, by a plurality of the soft magnetic metal particles P biting into the external electrodes 3, 4 due to the presswork during the manufacture of the coil component 1. Specifically, the portion where the soft magnetic metal particles P have not bitten into the second electrode portion 22 is the protrusion 22c. The protrusion 22c may be formed on the side surface 22a. A plurality of the protrusions 22c may be formed on the surface of the second electrode portion 22.

The external electrodes 3, 4 may further include a plating layer (not shown) that covers the exposed surface 21a. For example, the plating layer is not embedded in the element body 2 and is disposed outside of the mounting surface (main surface 2d). The plating layer is, for example, an Ni plating layer or an Sn plating layer. The plating layer may have a single layer structure or a multi-layer structure.

The bent shape of the external electrodes 3, 4 is achieved, for example, by the following method. Firstly, a plurality of green sheets including element body patterns and conductive patterns are laminated to form a laminated body. At this point, the conductive patterns to be the external electrodes 3, 4 are flat. Then, a green sheet to be the first element body portion 15 is further laminated on the portions of the conductive patterns to be the second electrode portions 22, among the conductive patterns to be the external electrodes 3, 4, and pressed in the lamination direction. Thus, the portions of the conductive patterns to be the second electrode portions 22, among the conductive patterns to be the external electrodes 3, 4, are pressed and bent toward the inside of the laminated body.

As described above, in the coil component 1, the external electrodes 3, 4 each has the second electrode portion 22 that projects into the element body 2 from the first electrode portion 21, with the entire second electrode portion 22 being provided inside the element body 2. Thus, a contact area between the external electrodes 3, 4 and the element body 2 is increased compared to a configuration in which the external electrodes 3, 4 do not have the second electrode portion 22. Consequently, detachment (falling off) of the external electrodes 3, 4 from the element body 2 is suppressed.

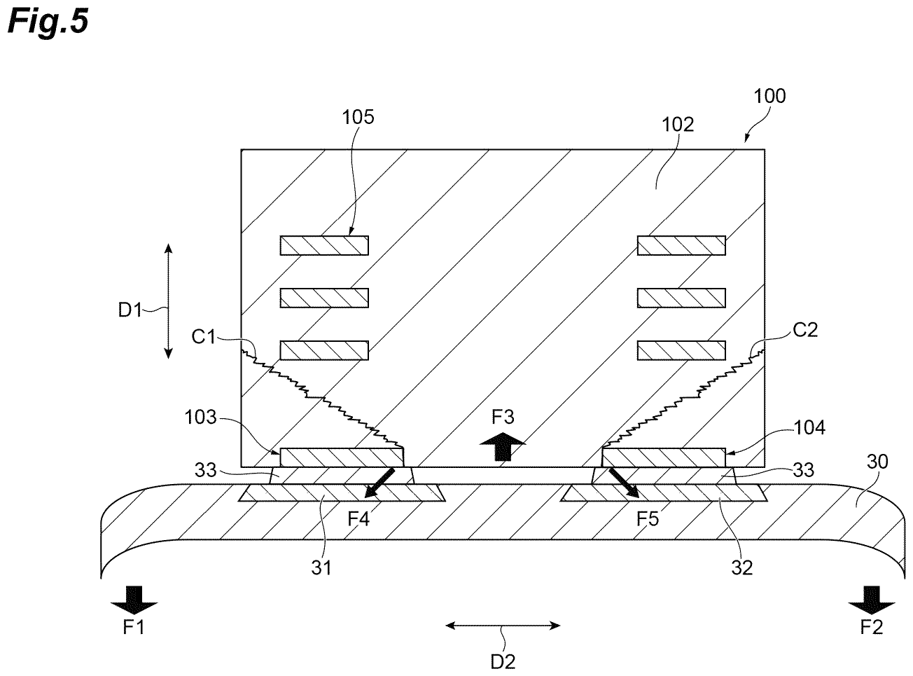

A coil component 100 according to a comparative example will be described with reference to FIG. 5. As illustrated in FIG. 5, in the coil component 100, external electrodes 103, 104 do not have a configuration corresponding to the second electrode portion 22 (see FIG. 4). The coil component 100 is used by being mounted on land electrodes 31, 32 of a circuit board 30 with solder 33. The external electrode 103 is connected to the land electrode 31. The external electrode 104 is connected to the land electrode 32.

For example, when the circuit board 30 bends, bending stresses F1, F2, F3 are generated in the circuit board 30. This causes tensile stresses F4, F5 to be applied on the external electrodes 103, 104. As a result, cracks C1, C2 originating from portions between the edge portions 21b of the first electrode portions 21 of the external electrodes 103, 104 and an element body 102 extend diagonally toward the outside of the element body 102 in the second direction D2 and the main surface 2c. If a coil 105 or a connecting conductor (not shown) is disconnected due to the cracks C1, C2, the function of the coil 105 may be lost.

However, in the coil component 1, the external electrodes 3, 4 have the second electrode portions 22. The second electrode portion 22 of the external electrode 3 projects from the edge portion 21b of the first electrode portion 21 toward the external electrode 4. Additionally, the second electrode portion 22 of the external electrode 4 projects from the edge portion 21b of the first electrode portion 21 toward the external electrode 3. The second electrode portions 22 are disposed so as to intersect with directions in which the cracks C1, C2 extend. Furthermore, the external electrodes 3, 4 are harder than the element body 2. Consequently, the second electrode portions 22 are capable of suppressing the extension of the cracks C1, C2.

The angle θ between the second electrode portion 22 and the mounting surface (main surface 2d) is greater than 0 degrees and less than 90 degrees. The second electrode portions 22 are thus more likely to intersect with the directions in which the cracks C1, C2 extend. Consequently, the extension of the cracks C1, C2 can be effectively suppressed by the second electrode portions 22.

The first element body portion 15 of the element body 2 includes the center region 2g, which is a part of the mounting surface (main surface 2d), and covers the second electrode portion 22. The first element body portion 15 includes a glass component, and is thus capable of suppressing plating elongation in the center region 2g. The first element body portion 15 further includes the soft magnetic metal particles P, and is thus capable of improving the properties of the coil component 1.

The second electrode portion 22 has the protrusion 22c that penetrates between the soft magnetic metal particles P, P. This further suppresses the detachment of the external electrodes 3, 4.

Although the embodiments of the present disclosure have been described above, the present disclosure is not necessarily limited to these embodiments, and various modifications are possible without departing from the gist thereof.

In the embodiments above, the coil component 1 has been described as an example of the coil component. However, the coil component is not limited to the coil component 1, and may be other coil components. For example, the numbers and shapes of the coil conductors forming the coil 5 are not limited.

Although the exposed surface 21a forms the same plane as the main surface 2d in the coil component 1, the exposed surface 21a may be positioned inward of the element body 2 than the main surface 2d, or may be positioned outside of the element body 2. Additionally, the exposed surface 21a is not limited to a flat surface and may be curved. The external electrodes 3, 4 may have different shapes from each other. As long as one of the external electrodes 3, 4 has the second electrode portion 22, the other need not have the second electrode portion 22.

The second electrode portion 22 may project from a portion other than the edge portion 21b of the first electrode portion 21. In this case, the side surface 22a of the second electrode portion 22 will not be directly adjacent the center region 2g. Consequently, the angle θ may be an angle between a virtual plane including the side surface 22a of the second electrode portion 22 and a virtual plane including the center region 2g.

What is claimed is:

1. A coil component, comprising:
an element body including soft magnetic metal particles;
a coil disposed inside the element body; and
a first external electrode embedded in the element body to be exposed only from a mounting surface of the element body and connected to the coil,
wherein the first external electrode includes a first electrode portion having an exposed surface exposed from the mounting surface, and a second electrode portion projecting into the element body from the first electrode portion and spaced apart from the coil, and
wherein an entirety of the second electrode portion is provided inside the element body.

2. The coil component according to claim 1, further comprising a second external electrode embedded in the element body to be exposed only from the mounting surface of the element body and connected to the coil,
wherein the first external electrode and the second external electrode are spaced apart from each other,
wherein the first electrode portion has an edge portion closer to the second external electrode, and
wherein the second electrode portion projects toward the second external electrode from the edge portion when viewed in a first direction perpendicular to the mounting surface.

3. The coil component according to claim 2, wherein an angle between the second electrode portion and the mounting surface is greater than 0 degrees and less than 90 degrees.

4. The coil component according to claim 1,
wherein the element body includes an element body portion including a part of the mounting surface and covering the second electrode portion, and
wherein the element body portion includes a glass component.

5. The coil component according to claim 4, wherein the element body portion further includes the soft magnetic metal particles.

6. The coil component according to claim 1, wherein the second electrode portion includes a protrusion penetrating between the soft magnetic metal particles.

7. The coil component according to claim 1, wherein: the element body includes an element body portion including a part of the mounting surface and covering the second electrode portion; and
a content of a glass component in the element body portion is greater than a content of the glass component in portions of the element body other than the element body portion.

8. The coil component according to claim 7, further comprising a second external electrode embedded in the element body to be exposed only from the mounting surface of the element body and connected to the coil,
wherein the first external electrode and the second external electrode are spaced apart from each other with the element body portion interposed therebetween.

9. The coil component according to claim 2, wherein each of the first external electrode and the second external electrode includes the first electrode portion and the second electrode portion.

10. The coil component according to claim 1, wherein the coil is connected to the first electrode portion.

11. A coil component, comprising:
an element body including soft magnetic metal particles;
a coil disposed inside the element body; and
a first external electrode and a second external electrode embedded in the element body to be exposed only from a mounting surface of the element body and connected to the coil,
wherein each of the first external electrode and the second external electrode includes a first electrode portion having an exposed surface exposed from the mounting surface, and a second electrode portion projecting into the element body from the first electrode portion and spaced apart from the coil;
wherein an entirety of the second electrode portion is provided inside the element body; and
wherein an angle between the second electrode portion and the mounting surface is greater than 0 degrees and less than 90 degrees.
